(19) United States
(12) Patent Application Publication
(10) Pub. No.: US 2014/0223580 A1
(43) Pub. Date: Aug. 7, 2014

(54) METHOD OF AND APPARATUS FOR PROCESSING SOFTWARE USING HASH FUNCTION TO SECURE SOFTWARE, AND COMPUTER-READABLE MEDIUM STORING EXECUTABLE INSTRUCTIONS FOR PERFORMING THE METHOD

(71) Applicant: Samsung Electronics Co., Ltd., Suwon-si (KR)

(72) Inventors: Andrii NEIVANOV, Kharkiv (UA); Mykola RAIEVSKYI, Kyiv (UA)

(73) Assignee: Samsung Electronics Co., Ltd., Suwon-si (KR)

(21) Appl. No.: 14/169,195

(22) Filed: Jan. 31, 2014

(30) Foreign Application Priority Data
Feb. 1, 2013 (KR) 10-2013-0011980

(51) Int. Cl. G06F 21/12

(52) U.S. Cl. CPC G06F 21/12
USPC 726/28

(57) ABSTRACT

A method and apparatus for processing software using a hash function to secure the software includes generating a first identifier using a hash function, from a first serial number, based on a user input; and generating a security execution file by combining the first identifier with the software, wherein the first serial number is authentication information used to verify an access right to the software. The method and apparatus further include, in response to receiving an outside request for access to the software, requesting information proving an access right; generating a second identifier using the hash function, from a second serial number that is included in the received information proving the access right; and in response to a determination that the second identifier matches the first identifier, allowing an access to the software.

### CROSS-REFERENCE TO RELATED PATENT APPLICATION

This application claims priority from Korean Patent Application No. 10-2013-0011980, filed on Feb. 1, 2013, in the Korean Intellectual Property Office, the disclosure of which is incorporated herein in its entirety by reference.

### BACKGROUND

1. Field

Methods and apparatuses consistent with exemplary embodiments relate to processing software using a hash function to secure the software.

2. Description of the Related Art

Along with an increase in the importance of software with regard to intelligent, green, and wireless information technology (IT) products, a threat of an attack using security vulnerabilities of software increases as well. While an on-line environment developed according to the nationwide establishment of a network infrastructure has caused the revitalization of web software, the risk of a security incident using a software vulnerability is gradually increasing within the open web.

Accordingly, requests for preventing software tampering are increasing. Software tampering refers to the injection of malicious code into software or tampering with the contents of software.

In more detail, to prevent illegal modification of software stored in a user device, verification of whether the software is identical to the original is required. Illegal modification of software may occur in various situations, such as in a case of hacking content protected by a copyright.

In addition, as one method of securing software, an access right to the software is checked to allow only users having legal authorization to access the software.

For example, to verify whether software has been illegally modified, an electronic signature method is representatively used. That is, an electronic signature for software is stored in a user device together with the software, and when an operation of the user device starts, whether the software is activated is determined according to a verification result of the electronic signature for the software.

The electronic signature method has an advantage that when software, such as firmware, is illegally modified, the modification can be checked. However, it may take a considerably long time according to the performance of a user device to verify whether an electronic signature is true.

In addition, to verify whether software has been illegally modified, software protected by a copyright may be executed only by an authorized computer using a security mechanism limited to a designated machine. An authorized computer may be checked according to whether a computer identification number (CIN) consisting of a serial number of a computer chip, a serial number of a hard disk, and a serial number of a computer operating system (OS) all match. However, such a problem still exists in that the CIN may be easily hacked by a hacker.

### SUMMARY

One or more exemplary embodiments provide a method of processing software to prevent the software from being tampered with or being reverse-engineered by a hacker by generating a security execution file from a combination of an identifier, which is generated using a hash function from a serial number based on a user input, and the software and using the identifier as authentication information to verify an access right to the software to block an unauthorized user's access.

One or more exemplary embodiments also provide a software processing apparatus for processing the method.

One or more exemplary embodiments also provide a non-transitory computer-readable medium having stored therein program instructions, which when executed by a computer, perform the method.

According to an aspect of an exemplary embodiment, there is provided a method of processing software to secure the software, the method including: generating a first identifier using a hash function, from a first serial number, based on a user input; and generating a security execution file by combining the first identifier with the software, wherein the first serial number is authentication information used to verify an access right to the software.

The method may further include, before the generating of the first identifier: generating a pseudo-random number string; and selecting the first serial number from the pseudo-random number string based on an input of a user having an access right to the software.

The generating of the first identifier may include: calculating a hash value for the first serial number; and generating the first identifier corresponding to the hash value of the first serial number.

The security execution file may include the hash function.

The method may further include, in response to receiving an outside request for access to the software, requesting information proving an access right; generating a second identifier using the hash function, from a second serial number that is included in the received information proving the access right; and in response to a determination that the second identifier matches the first identifier, allowing an access to the software.

In response to the determination that the second identifier matches the first identifier, the second serial number is used as the authentication information for verifying the access right to the software, and in response to a determination that the second identifier does not match the first identifier, the second serial number cannot be used as the authentication information for verifying the access right to the software.

The generating of the second identifier may further include calculating a hash value of the second serial number and generating the second identifier corresponding to the hash value of the second serial number.

According to an aspect of another exemplary embodiment, there is provided an apparatus for processing software to secure the software, the apparatus including a first identifier generator configured to generate a first identifier using a hash function from a first serial number based on a user input; and a security execution file generator configured to generate a security execution file by combining the first identifier with the software, wherein the first serial number is authentication information used to verify an access right to the software.

The apparatus may further include: a pseudo-random number string generator configured to generate a pseudo-random number string; and a first serial number selector configured to select the first serial number from the pseudo-random number string based on an input of a user having an access right to the software.

The first identifier generator may include a first hash value calculator configured to calculate a hash value for the first serial number, and the first hash value calculator may be further configured to generate the first identifier based on the calculated hash value of the first serial number.

The apparatus may further include an access right information request unit configured to, in response to receiving an outside request for access to the software, request information proving an access right; a second identifier generator configured to generate a second identifier using the hash function from a second serial number that is included in the received information proving the access right; and an identifier matching determiner configured to determine whether the second identifier matches the first identifier.

The second identifier generator may further include a second hash value generator configured to calculate a hash value of the second serial number, and the second hash value generator may be further configured to generate the second identifier based on the calculated hash value of the second serial number.

The identifier matching determiner, in response to a determination that the second identifier is identical to the first identifier, may be configured to use the second serial number as the authentication information for verifying the access right to the software, and the identifier matching determiner, in response to a determination that the second identifier does not match the first identifier, is configured not to use the second serial number as the authentication information for verifying the access right to the software.

According to an aspect of another exemplary embodiment, there is provided a non-transitory computer-readable medium storing a program causing a computer to execute a method for processing software to secure the software, the method including generating a first identifier using a hash function, from a first serial number, based on a user input; and generating a security execution file by combining the first identifier with the software, wherein the first serial number is authentication information used to verify an access right to the software.

### BRIEF DESCRIPTION OF THE DRAWINGS

The above and other aspects will become more apparent by describing in detail exemplary embodiments with reference to the attached drawings in which:

FIG. 1 is a flowchart illustrating a method of processing software to generate a security execution file of the software, according to an exemplary embodiment;

FIG. 2 is a conceptual block diagram that illustrates generating an identifier, according to an exemplary embodiment;

FIG. 3 is a conceptual block diagram that illustrates generating a security execution file of software using an identifier, according to an exemplary embodiment;

FIG. 4 is a flowchart illustrating a method of generating an identifier to be used to generate a security execution file, according to an exemplary embodiment;

FIG. 5 is a flowchart illustrating a method of processing software in response to an access request from the outside desiring access to the software, according to another exemplary embodiment;

FIG. 6 is a flowchart illustrating a method of verifying an access right to software in response to an access request from the outside desiring access to the software, according to another exemplary embodiment;

FIGS. 7 and 8 are conceptual block diagrams of verifying an access right to software, according to another exemplary embodiment; and

FIGS. 9 and 10 are block diagrams illustrating an apparatus for processing software, according to an exemplary embodiment.

### DETAILED DESCRIPTION

The exemplary embodiments may allow various kinds of change or modification and various changes in form, and specific embodiments will be illustrated in drawings and described in detail in the specification. However, it should be understood that the exemplary embodiments do not limit the present general inventive concept to a specific form but include every modified, equivalent, or replaced one within the spirit and technical scope of the exemplary embodiments.

Although terms, such as ‘first’ and ‘second’, may be used to describe various elements, the elements are not be limited by the terms. The terms may be used to distinguish a certain element from another element.

The terminology used in the application is used only to describe specific embodiments and does not limit the present general inventive concept. An expression in the singular includes an expression in the plural unless they are clearly different from each other in a context. In the application, it should be understood that terms, such as ‘include’ and ‘have’, are used to indicate the existence of implemented feature, number, step, operation, element, part, or a combination of them without excluding in advance the possibility of existence or addition of one or more other features, numbers, steps, operations, elements, parts, or combinations of them.

Exemplary embodiments will now be described more fully with reference to the accompanying drawings. Like reference numerals in the drawings denote like elements, and thus their repetitive description will be omitted.

Hereinafter, a method of processing software using a hash function to secure the software according to exemplary embodiments, an apparatus therefor, and a non-transitory computer-readable storage medium having stored therein program instructions, which, when executed by a computer, perform the method, will be described with reference to the accompanying drawings.

In the description below, for clarity of understanding of the exemplary embodiments, descriptions of well-known technology related to features of the exemplary embodiments will be omitted. The embodiments below are detailed descriptions for helping the understanding of the present general inventive concept and do not limit the scope of the present general inventive concept. Therefore, equivalent embodiments performing the same functions as the exemplary embodiments will also belong to the scope of the present general inventive concept. In the description below, like reference numerals denote like elements, and unnecessary repetitive descriptions and descriptions of well-known technology will be omitted.

As used herein, the term “and/or” includes any and all combinations of one or more of the associated listed items. Expressions such as “at least one of,” when preceding a list of elements, modify the entire list of elements and do not modify the individual elements of the list.

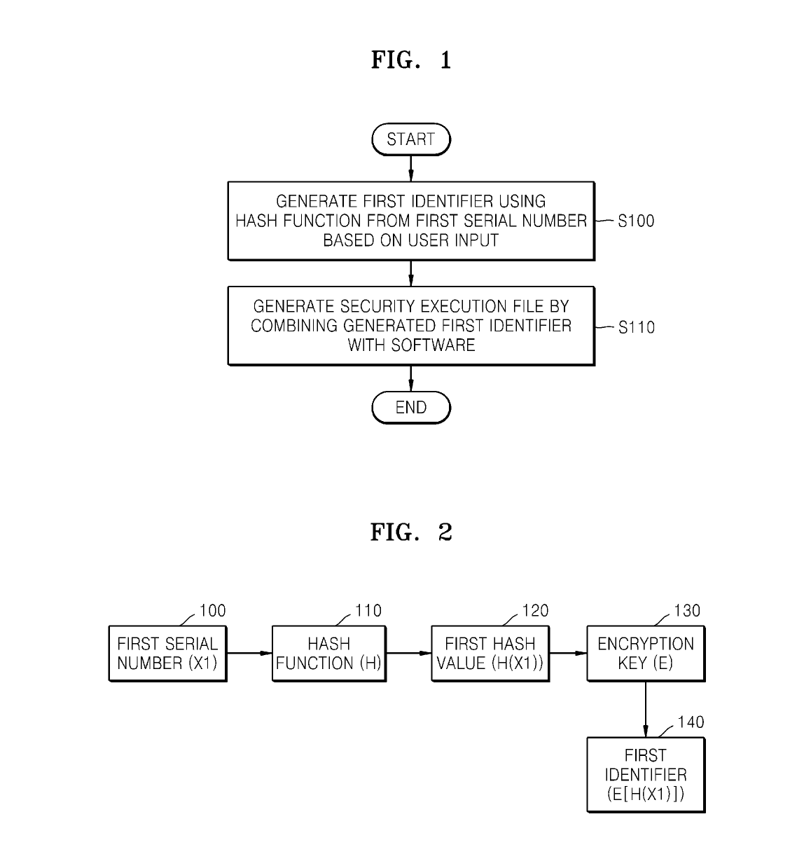

FIG. 1 is a flowchart illustrating a method of processing software to generate a security execution file of the software, according to an exemplary embodiment.

Software may be implemented in various forms. Software described in the specification indicates one or more computer programs having a specific purpose, which are stored in a storage device. Program software performs a function by directly providing instructions to computer hardware or providing an input to other software. In addition, unlike a file simply storing only data, an execution file indicates a computer file for performing a task directed by an encrypted command. Files including instructions for an interpreter, a central processing unit (CPU), or a virtual machine may be considered to be execution files, but in more detail, these files are scripts or byte codes. An execution file is called a binary file compared with primitive code of a program. In general, execution files interact with each other in an operating system (OS), and some OSs identify execution files based on a file extension or recognize files based on metadata. Most OSs check whether a corresponding file has a valid execution file format to thereby protect an arbitrary bit sequence from accidentally and carelessly being executed as a command. The present OSs have a control right for managing resources of a computer, and with the control right, an OS requests each program to call a system to access an allowed resource. Since each OS group has its own call structure, execution files are generally limited to a specific OS.

In operation S100, a first identifier is generated using a hash function from a first serial number based on a user input.

For example, the first serial number is authentication information to be used by a user to verify an access right to the software and may be generated based on an input of a user having an access right to the software. In addition, when the first identifier is generated, a pseudo-random number string may be generated, and the first serial number may be selected from the generated pseudo-random number string based on an input of the user having an access right to the software. In this case, the first serial number indicates one or more continuous numbers selected from the pseudo-random number string, and at least one first serial number may be selected according to an input of the user.

In addition, the hash function is a function of receiving an arbitrary-sized message M as an input and outputting a constant-sized message digest H(M). A method of segmenting data and replacing or modifying positions of the segmented data is usually used to generate a hash value. In addition, the hash function operates using a deterministic algorithm, and the deterministic algorithm is an algorithm that operates as predicted and indicates that a same result is always output through a same process upon receiving a specific input, i.e., that when two hash values are different from each other, original data for the two hash values are also different from each other. According to an exemplary embodiment, when the first identifier generated using the hash function from the first serial number is different from a second identifier generated using the hash function from a second serial number, it indicates that the first serial number is different from the second serial number. In the exemplary embodiment, since the first serial number is authentication information used to verify an access right to the software, if the second serial number is different from the first serial number, the second serial number cannot be authentication information used to verify an access right to the software, and accordingly, when the second serial number is received, the software cannot be executed.

In addition, the hash function is characterized as a one way function indicating a function of transforming inputs having various lengths to outputs having a fixed short length and is used for integrity verification and message authentication. For example, a message authentication code (MAC) may be generated using the hash function. In general, the hash function, which is a one way function, is used to generate an MAC, but according to an exemplary embodiment, an access right to software may be verified using the hash function.

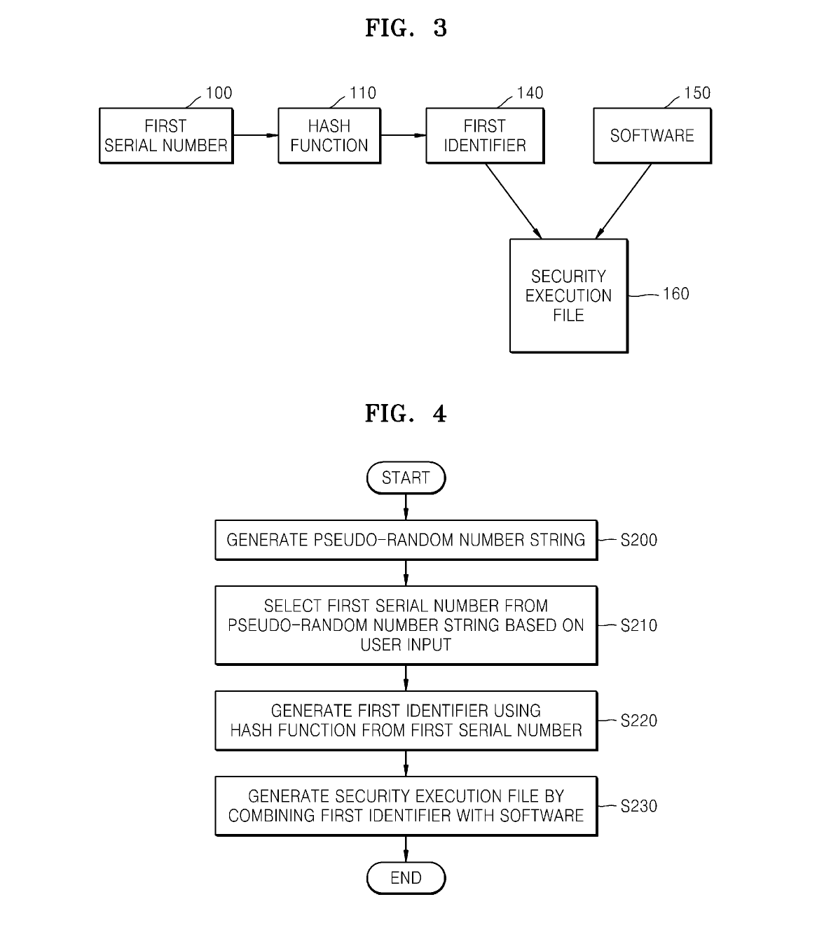

For example, the arbitrary-sized message M in the hash function may be the first serial number according to an exemplary embodiment. When the first serial number is used as an input value of the hash function, a hash value may be obtained as an output value thereof. A detailed description thereof will be made with reference to FIG. 2.

The first identifier is generated using the hash function from the first serial number based on a user input. The generation of the first identifier using the hash function, which is a one way function, provides a method of processing software to prevent the software from being tampered with or being reverse engineered by a hacker. By using the first identifier as authentication information used to verify an access right to the software, access to the software by an unauthorized user may be prevented.

In operation S110, a security execution file is generated by combining the generated first identifier with the software.

In more detail, the security execution file in which the first identifier is combined with an execution file of the software is generated to use the first identifier in the verification of an access right to the software when an access request is received from the outside desiring to access the software.

FIG. 2 is a conceptual block diagram that illustrates generating a first identifier 140, according to an exemplary embodiment. The first identifier 140, which is to be used to verify an access right to software in a security execution file, requires confidentiality and integrity. Confidentiality is directed to inappropriate exposure prevention and allowing access to the software only by an authorized user, and integrity is directed to preventing the software from being inappropriately tampered with and preventing the contents of the software from being changed by an unauthorized user. For confidentiality and integrity, the software is allowed to be executed only if an access right to the software is accepted by verifying the access right to the software every time an access to the software is requested. To this end, the first identifier 140 is a cryptogram, and a plaintext for which protection is sought is a first serial number 100.

For example, the first identifier 140 may be a hash value 120 generated using a hash function 110 from the first serial number 100 or be a value obtained by encrypting the hash value 120 using an encryption key 130. The hash function 110 makes the first serial number 100 having an arbitrary length correspond to the hash value 120 having a fixed length. The hash function 110 is a public function, and it does not have to be encrypted.

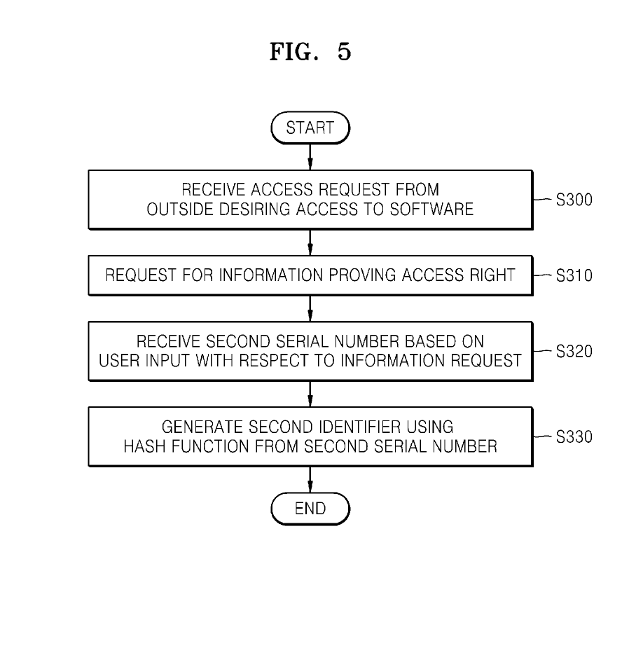

FIG. 3 is a conceptual block diagram that illustrates generating a security execution file 160 of software 150 using the first identifier 140, according to an exemplary embodiment.

The first serial number 100 is generated based on an input of a user having a legal access right to the software 150. The first identifier 140, which is generated from the first serial number 100, should be used to verify an access right to the software 150. Thus, the first identifier 140 may be generated using the hash function 110, which is a one way function, of which inverse transformation cannot be performed, and a security execution file 160 may be generated by combining the first identifier 140 with the software 150 to use the generated first identifier 140 as authentication information. When an identifier the same as the first identifier 140 in the security execution file 160 is recognized by a request of the outside desiring to access the software 150, the software 150 in the security execution file 160 may be executed.

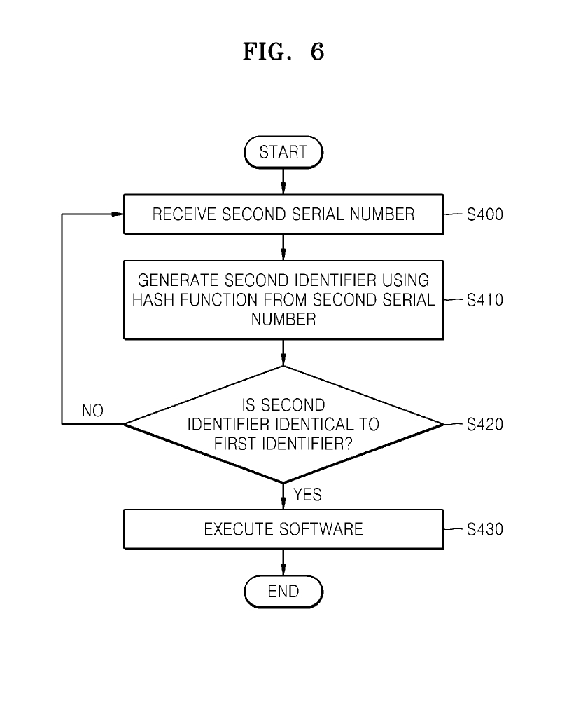

FIG. 4 is a flowchart illustrating a method of generating an identifier to be used to generate a security execution file, according to an exemplary embodiment.

The identifier according to an exemplary embodiment may be authentication information used to verify an access right to software by being combined with the software to block access by an unauthorized user. Thus, to prevent an unauthorized user from reverse engineering a software program, the identifier may be generated using a hash function, which is a one way function. In this case, an output value of the hash function may be the identifier, and an input value of the hash function may be the first serial number according to an exemplary embodiment. When the security execution file is generated, the first serial number may be generated based on an input of a user having an access right to the software, wherein the first serial number may be directly input by the user.

In operation S200, a pseudo-random number string is generated before generating the first identifier.

A pseudo-random number indicates an arbitrary random number, i.e., an unpredictable number. According to a method of generating a random number, a pseudo-random number string is generated through a specific formula by repeating the following operations of 1) starting from an initial seed, 2) generating a number using the specific formula, and 3) designating the generated number as a seed. That is, generating a number string that looks arbitrary is a software random number generating method. Thus, since these numbers are not true random numbers, the numbers are called pseudo-random numbers. Since the pseudo-random number string is a calculated number string, the same numbers will be repeated according to a calculation scheme, but if a calculation period is long, the pseudo-random number string may be substantially equivalent to a random number. In addition, to look like a list of arbitrary numbers, a distribution of numbers generated in one period should be uniform. However, even though the generated numbers look arbitrary, the generated numbers are not unpredictable. Since pseudo-random numbers also are generated by calculation, if a calculation scheme is known, it is theoretically possible to predict the pseudo-random numbers, and if an internal initial seed is known, the pseudo-random numbers may be previously calculated. As such, a code for generating random numbers in software is called a pseudo-random number generator (PRNG). A representative example of algorithms of generating a pseudo-random number string is a linear congruential method.

In operation S210, the first serial number is selected from the pseudo-random number string based on an input of a user having a legal access right to the software.

To further reinforce security, the user may select a serial number from the pseudo-random number string generated by software instead of the user directly inputting the first serial number. A data size of the serial number may not be limited. In addition, the first serial number may be selected in at least one number from the pseudo-random number string. Data sizes of the selected at least one first serial number may be various.

In operation S220, the first identifier is generated from the selected at least one first serial number using the hash function.

For example, when the number of first serial numbers selected based on an input of the user is plural, a first identifier may be generated from each of the first serial numbers using the hash function. In addition, the first identifier may be a hash value generated using the hash function from the first serial number or be a value obtained by encrypting the hash value. In this case, a key may be used in a method of encrypting the hash value, the key is used to encrypt a plaintext to a cryptogram and may be used to decrypt the cryptogram. The key may be used for authentication, a digital signature structure, and the like. In addition, there may be a symmetric encryption method in which a same key is used as a secret key in encryption and decryption and a public key encryption method in which different keys, i.e., a private key and a public key, are used for encryption and decryption. For example, there may be a message authentication code for a sender and a recipient to perform authentication by using a common key and a digital signature in which different keys are used in writing a signature and verifying the signature. As described above, since a person who does not know a true key cannot modify or tamper with data, if the first identifier according to an exemplary embodiment is encrypted using a key from the hash value generated using the hash function from the first serial number, the key used for the encryption may be used as a key for authentication. As described above, by generating the hash value using the hash function, which is a one way function, and encrypting the hash value using a key, security for verifying an access right to the software according to an exemplary embodiment is strengthened compared to related art methods.

The hash function is a public function, and it makes the first serial number having an arbitrary length correspond to the hash value having a fixed length. The hash function does not have to be encrypted.

In operation S230, a security execution file is generated by combining the generated first identifier with the software.

When the at least one first serial number is generated from the pseudo-random number string by a selection based on an input of the user, at least one first identifier may be respectively generated using the hash function from the at least one first serial number. In this case, the security execution file may be generated by combining a set of the generated at least one first identifiers with the software. By doing so, multiple pieces of authentication information may be used to verify an access right to the software.

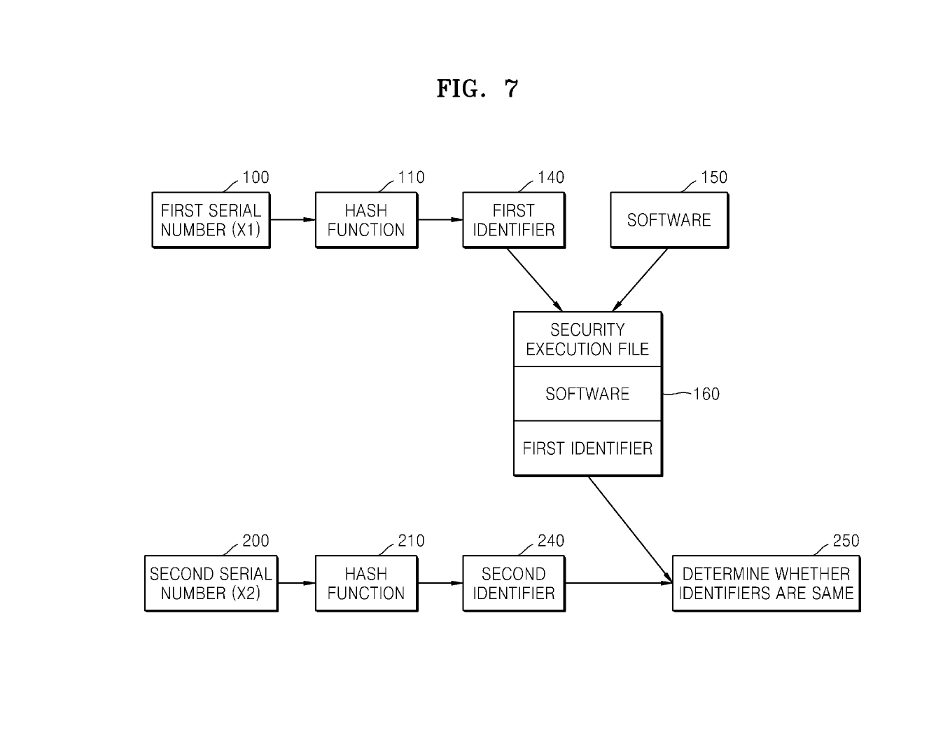

FIG. 5 is a flowchart illustrating a method of processing software in response to an access request from the outside desiring access to the software, according to another exemplary embodiment.

In operation S300, an access request is received from the outside desiring access to the software.

To execute a security execution file generated by combining a first identifier with the software, an access right to the software is verified. The first identifier may be used as authentication information to be used to verify the access right.

In operation S310, if the access request is received, information proving the access right is requested.

To prevent tampering with or reverse engineering of software by a hacker, authentication of an access right to the software is necessary for blocking access by an unauthorized user. To this end, the information proving the access right is requested to verify an access right to the software. For example, the security execution file may generate a pop-up window as a window for inputting a predetermined serial number required to verify the access right. In addition, the information proving the access right may be requested by moving a cursor to a field of the pop-up window for inputting the information proving the access right.

In operation S320, a second serial number is received based on a user input with respect to the information request.

For example, the software may receive the information proving the access right based on a user input, which is input into the field of the pop-up window to which the cursor moves. The information proving the access right may be a serial number based on a user input, and the serial number may be the second serial number. That is, the second serial number may be used as authentication information to be used to verify an access right, according to an exemplary embodiment. When the second serial number is identical to the first serial number, an access to the software may be allowed. In addition, even though the second serial number is identical to at least one of a plurality of first serial numbers, the access may be allowed.

In operation S330, a second identifier is generated using a hash function from the received second serial number.

According to an exemplary embodiment, to further increase security in authentication of an access right to the software, rather than the first serial number being generated based on a user input, the first identifier may be generated by calculating a hash value using the hash function from the first serial number or encrypting the calculated hash value using a key. Thus, even though the second serial number being generated based on a user input is received in operation S320, the second serial number also needs to be transformed to compare the second serial number with the first identifier combined in the security execution file.

When the second identifier is generated using the hash function from the second serial number, the hash function should be identical to the hash function used to generate the security execution file. The hash function may be included in the security execution file. In addition, an authorized user having an access right to the software may share the hash function in advance. The hash function is a public function and does not have to be encrypted.

Only if an algorithm of generating the first identifier is the same as an algorithm of generating the second identifier, whether an access to the software is allowed may be selectively determined according to whether the second identifier is identical to the first identifier.

For example, when the first identifier combined in the security execution file is a hash value calculated from the first serial number, the second identifier may be a hash value calculated from the second serial number. In addition, when the first identifier combined in the security execution file is obtained by encrypting the hash value, which has been calculated from the first serial number, using a key, the second identifier may be obtained by encrypting the hash value, which has been calculated from the second serial number, using the key.

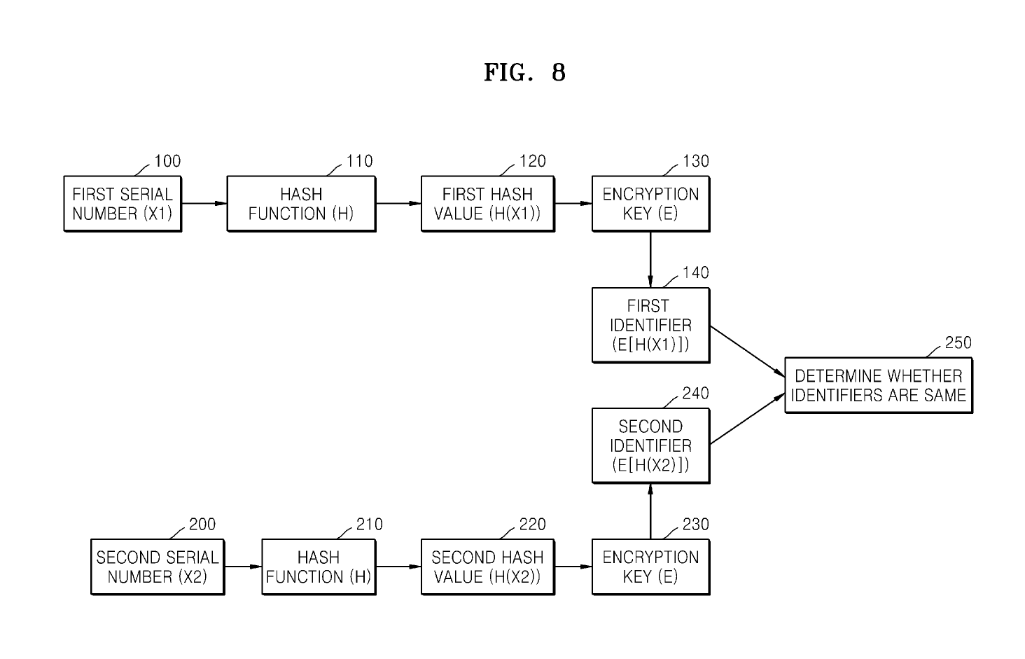

FIG. 6 is a flowchart illustrating a method of verifying an access right to software in response to an access request of the outside desiring to access the software, according to another exemplary embodiment.

Operation S400 is the same as operation S320 of FIG. 5.

Operation S410 is the same as operation S330 of FIG. 5.

In operation S420, an access to the software is selectively allowed according to whether the second identifier is identical to the first identifier. For example, if the second identifier is identical to the first identifier, the second serial number may be used as authentication information to be used to verify an access right to the software, and if the second identifier is not identical to the first identifier, the second serial number cannot be used as authentication information to verify an access right to the software. In addition, when it is determined whether the second identifier is identical to the first identifier, a case where the second identifier is identical to at least one of a plurality of first identifiers may be included.

If the second identifier is not identical to the first identifier, it indicates that an access right to the software is not verified, and thus, the software cannot be executed, and the method proceeds back to operation S400.

In operation S430, if an access right to the software is verified, the software is executed.

Access to the software is selectively allowed according to whether the second identifier is identical to the first identifier combined in a security execution file, and when the second identifier is identical to the first identifier, an access right to the software may be verified. Thus, the software of the security execution file may be executed.

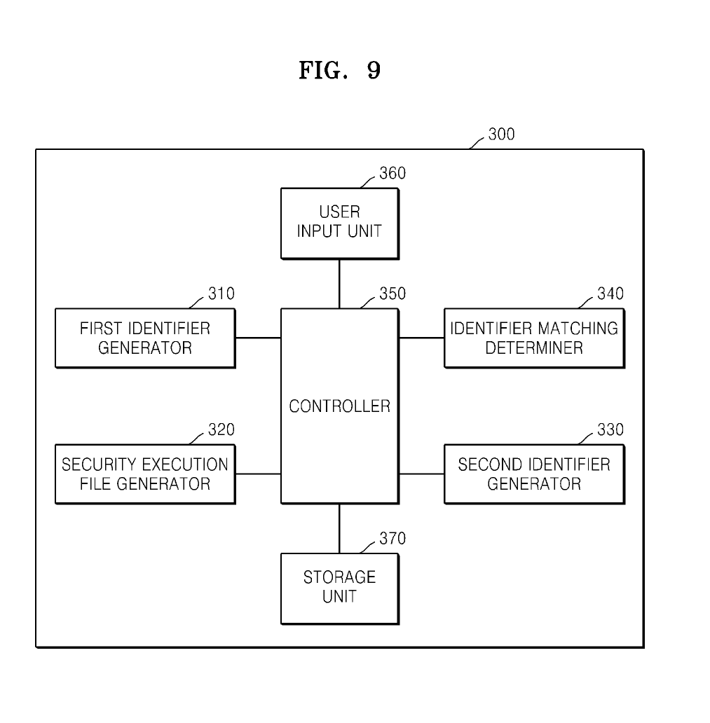

FIGS. 7 and 8 are conceptual block diagrams that illustrate verifying an access right to software, according to another exemplary embodiment.

FIG. 7 is a conceptual block diagram that illustrates determining whether a first identifier 140 combined with a software 150 is identical to a second identifier 240 that is a hash value calculated from a second serial number 200 when the first identifier 140 is a hash value calculated from a first serial number 100. In addition, FIG. 8 is a conceptual block diagram that illustrates determining whether the first identifier 140 combined with the software 150 of FIG. 7 is identical to the second identifier 240 obtained by encrypting a second hash value 220, which has been calculated from the second serial number 200, using an encryption key 230 when the first identifier 140 is obtained by encrypting a first hash value 120, which has been calculated from the first serial number 100, using an encryption key 130.

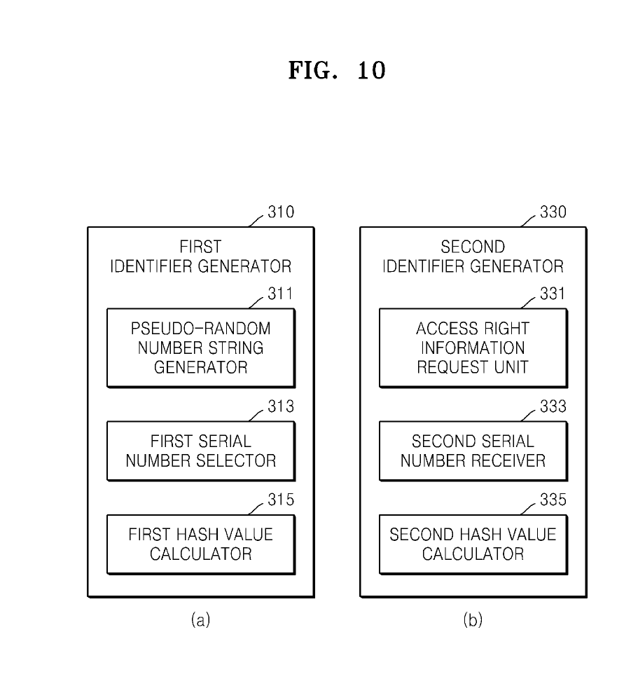

FIGS. 9 and 10 are block diagrams illustrating an apparatus 300 for processing software, according to an exemplary embodiment.

A first identifier generator 310 generates a first identifier using a hash function from a first serial number based on a user input. In addition, the first identifier generator 310 may further include a pseudo-random number string generator 311 for generating a pseudo-random number string and a first serial number selector 313 for selecting a first serial number from the pseudo-random number string based on an input of a user having a legal access right to the software, to thus strengthen security in the generation of the first identifier.

In addition, the first identifier generator 310 includes a first hash value calculator 315 for calculating a hash value for the first serial number, and the first identifier may be generated based on the hash value calculated by the first hash value calculator 315. In addition, the first identifier may be the hash value generated using a hash function from the first serial number or be a value obtained by encrypting the hash value.

A security execution file generator 320 generates a security execution file by combining the first identifier generated by the first identifier generator 310 with the software.

A second identifier generator 330 requests information proving an access right when an access request is received from the outside desiring access to the software and generates a second identifier using the hash function from a second serial number that is an input responding to the access request.

In addition, when the first identifier combined in the security execution file is the hash value calculated from the first serial number, the second identifier may be a hash value calculated from the second serial number. In addition, when the first identifier combined in the security execution file is the value obtained by encrypting the hash value, which has been calculated from the first serial number, using a key, the second identifier may be a value obtained by encrypting the hash value, which has been calculated from the second serial number, using the key.

In addition, the second identifier generator 330 may include an access right information request unit 331 for receiving an access right request from the outside desiring access to the software and a second serial number receiver 333 for receiving the second serial number based on a user input responding to the access right request.

In addition, the second identifier generator 330 may include a second hash value calculator 335 for calculating the hash value of the second serial number and may generate the second identifier based on the hash value calculated by the second hash value calculator 335.

An identifier matching determiner 340 determines whether the second identifier generated by the second identifier generator 330 is identical to the first identifier generated by the first identifier generator 310. In addition, a case where the second identifier is identical to at least one of a plurality of first identifiers may also be included.

If it is determined by the identifier matching determiner 340 that the second identifier is identical to the first identifier, the second identifier may be used as authentication information to verify an access right to the software, and if it is determined by the identifier matching determiner 340 that the second identifier is not identical to the first identifier, the second identifier cannot be used as authentication information to verify an access right to the software.

A storage unit 370 may store the first identifier to be combined with the security execution file and may store the hash function.

A user input unit 360 generates user input data for controlling an operation of the apparatus 300. According to an exemplary embodiment, the first serial number and the second serial number may be input into the apparatus 300 based on a user input by using the user input unit 360.

A controller 350 may control the first identifier generator 310, the pseudo-random number string generator 311, the first serial number selector 313, the first hash value calculator 315, the security execution file generator 320, the second identifier generator 330, the access right information request unit 331, the second serial number receiver 333, the second hash value calculator 335, the identifier matching determiner 340, the storage unit 370, and the user input unit 360.

According to the exemplary embodiments, provided is a method of processing software to prevent the software from being tampered with or being reverse engineered by a hacker, by generating a security execution file from a combination of an identifier, which is generated using a hash function from a serial number based on a user input, and the software and by using the identifier as authentication information to verify an access right to the software to block an unauthorized user's access.

In more detail, since the identifier is a value generated using the hash function, which is a one way function, reverse engineering of the software is difficult, and accordingly, security of access to the software is strengthened.

Such a program may be recorded in a computer-readable recording medium and executed by a computer to execute the functions described above.

As described above, to execute a method of processing software according to each of the exemplary embodiments, the program may include codes coded by a computer language, such as C, C++, JAVA, a machine language, or the like, which are readable by a processor (CPU) of a computer.

These codes may include functional codes related to a mathematical function in which the functions described above are defined and may include control codes related to execution procedures, which are required for the processor of the computer to execute the functions described above according to predetermined procedures.

In addition, these codes may further include additional information required for the processor of the computer to execute the functions described above and memory reference-related codes with respect to a location (address) within an internal or external memory of the computer.

In addition, when the processor of the computer needs to communicate with any other remote computer or server to execute the functions described above, the codes may further include communication-related codes with respect to how the processor of the computer communicates with any other remote computer or server using a communication module (e.g., a wired and/or wireless communication module) of the computer, what kind of information or media is to be transmitted and received in the communication, and the like.

The functional programs for embodying the exemplary embodiments, and codes and code segments related to the functional programs, may be easily construed or changed by programmers in the art to which the exemplary embodiments belong when a system environment of the computer for executing the program by reading a recording medium is taken into account.

Examples of the computer-readable recording medium in which the program is recorded include ROM, RAM, CD-ROM, magnetic tapes, floppy disks, optical media storage devices, and the like.

The computer-readable recording medium can also be distributed over a network coupled computer system so that the computer-readable code is stored and executed in a distributed fashion. In this case, at least one of a plurality of distributed computers may execute a portion of the functions described above and transmit an execution result to other least one of the plurality of distributed computers, and the computer, which has received the execution result, may also execute a portion of the functions described above and transmit an execution result to other distributed computers.

Although it has been described in the above description that all components forming the exemplary embodiments are combined in one body or operate in a combination of the components, exemplary embodiments are not necessarily limited in such a manner. That is, all the components may be selectively combined in one body. In addition, although each of all the components may be implemented as independent hardware, a portion or all of the components may be selectively combined and implemented as a computer program having a program module for performing a portion or all of functions combined in one or a plurality of pieces of hardware. Codes and code segments forming the computer program may be easily construed by one of ordinary skill in the art to which the exemplary embodiments belong. The computer program may be stored in a computer-readable recording medium and read and executed by a computer to implement an exemplary embodiment. Examples of the computer-readable recording medium of the computer program may include magnetic recording media, optical recording media, and the like.

In addition, it should be understood that terms such as ‘include’, ‘form’, or ‘have’, which are described above, do not exclude other components but can further include other components since the terms indicate that corresponding components may be involved unless the disclosure indicates otherwise. All terms used herein including technical or scientific terms have the same meaning as those generally understood by one of ordinary skill in the art unless they are defined differently. It should be understood that terms generally used, which are defined in a dictionary, have the same meaning as in a context of related technology, and the terms are not understood as ideal or excessively formal meaning unless they are clearly defined in the exemplary embodiments.

The above description is merely an illustrative description of the technical idea of exemplary embodiments, and it will be understood by one of ordinary skill in the art that various changes in form and details may be made therein without departing from the spirit and scope of the present general inventive concept. Therefore, the exemplary embodiments set forth are not meant to limit but to describe the technical idea of the exemplary embodiments, and the scope of the technical idea of the present general inventive concept is not limited by the embodiments. The scope of the present general inventive concept for which protection is sought should be analyzed by the following claims, and it should be understood that all technical ideas within its equivalent scope are included in the scope of the present general inventive concept.

What is claimed is:

1. A method of processing software to secure the software, the method comprising:
generating a first identifier using a hash function, from a first serial number, based on a user input; and
generating a security execution file by combining the first identifier with the software,
wherein the first serial number is authentication information used to verify an access right to the software.

2. The method of claim 1, further comprising:
in response to receiving an outside request for access to the software, requesting information proving an access right;
generating a second identifier using the hash function, from a second serial number that is included in the received information proving the access right; and
in response to a determination that the second identifier matches the first identifier, allowing an access to the software.

3. The method of claim 2, wherein, in response to the determination that the second identifier matches the first identifier, the second serial number is used as the authentication information for verifying the access right to the software, and
in response to a determination that the second identifier does not match the first identifier, the second serial number cannot be used as the authentication information for verifying the access right to the software.

4. The method of claim 1, further comprising, before the generating of the first identifier:
generating a pseudo-random number string; and
selecting the first serial number from the pseudo-random number string based on an input of a user having an access right to the software.

5. The method of claim 1, wherein the generating of the first identifier comprises:
calculating a hash value for the first serial number; and
generating the first identifier corresponding to the hash value of the first serial number.

6. The method of claim 1, wherein the security execution file includes the hash function.

7. The method of claim 2, wherein the generating of the second identifier comprises:
calculating a hash value of the second serial number; and
generating the second identifier corresponding to the hash value of the second serial number.

8. An apparatus for processing software to secure the software, the apparatus comprising:
a first identifier generator configured to generate a first identifier using a hash function, from a first serial number, based on a user input; and
a security execution file generator configured to generate a security execution file by combining the first identifier with the software,
wherein the first serial number is authentication information used to verify an access right to the software.

9. The apparatus of claim 8, further comprising:
an access right information request unit configured to, in response to receiving an outside request for access to the software, request information proving an access right;
a second identifier generator configured to generate a second identifier using the hash function, from a second serial number that is included in the received information proving the access right; and
an identifier matching determiner configured to determine whether the second identifier matches the first identifier.

10. The apparatus of claim 8, further comprising:
a pseudo-random number string generator configured to generate a pseudo-random number string; and
a first serial number selector configured to select the first serial number from the pseudo-random number string based on an input of a user having an access right to the software.

11. The apparatus of claim 8, wherein the first identifier generator comprises a first hash value calculator configured to calculate a hash value for the first serial number, and
the first hash value calculator is further configured to generate the first identifier based on the calculated hash value of the first serial number.

12. The apparatus of claim 9, wherein the second identifier generator comprises a second hash value generator configured to calculate a hash value of the second serial number, and
the second hash value generator is further configured to generate the second identifier based on the calculated hash value of the second serial number.

13. The apparatus of claim 9, wherein the identifier matching determiner, in response to a determination that the second identifier is identical to the first identifier, is configured to use the second serial number as the authentication information for verifying the access right to the software, and
the identifier matching determiner, in response to a determination that the second identifier does not match the first identifier, is configured not to use the second serial number as the authentication information for verifying the access right to the software.

14. A non-transitory computer-readable medium storing a program causing a computer to execute a method for processing software to secure the software, the method comprising:
generating a first identifier using a hash function, from a first serial number, based on a user input; and
generating a security execution file by combining the first identifier with the software,
wherein the first serial number is authentication information used to verify an access right to the software.

15. The non-transitory computer readable medium of claim 14, further comprising:
in response to receiving an outside request for access to the software, requesting information proving an access right;
generating a second identifier using the hash function, from a second serial number that is included in the received information proving the access right; and
in response to a determination that the second identifier matches the first identifier, allowing an access to the software.

16. The non-transitory computer readable medium of claim 15, wherein, in response to the determination that the second identifier matches the first identifier, the second serial number is used as the authentication information for verifying the access right to the software, and
in response to a determination that the second identifier does not match the first identifier, the second serial number cannot be used as the authentication information for verifying the access right to the software.

17. The non-transitory computer readable medium of claim 14, further comprising, before the generating of the first identifier:
generating a pseudo-random number string; and
selecting the first serial number from the pseudo-random number string based on an input of a user having an access right to the software.

18. The non-transitory computer readable medium of claim 14, wherein the generating of the first identifier comprises:
calculating a hash value for the first serial number; and
generating the first identifier corresponding to the hash value of the first serial number.

19. The non-transitory computer readable medium of claim 14, wherein the security execution file includes the hash function.

20. The non-transitory computer readable medium of claim 15, wherein the generating of the second identifier comprises:
calculating a hash value of the second serial number; and
generating the second identifier corresponding to the hash value of the second serial number.
